(19) United States
(12) Patent Application Publication
(10) Pub. No.: US 2009/0151306 A1
(43) Pub. Date: Jun. 18, 2009

(54) Dust removing device for dust collector

(75) Inventor: Kun Yi Lin, Taichung (TW)

Correspondence Address: CHARLES E. BAXLEY, ESQUIRE, 90 JOHN STREET, SUITE 309, NEW YORK, NY, 10038, US

(73) Assignee: Chang Tjer Industrial Co., Ltd.

(21) Appl. No.: 12/002,062

(22) Filed: Dec. 13, 2007

(51) Int. Cl. B01D 46/04

(52) U.S. Cl. 55/295

(57) ABSTRACT

A dust collector includes a filter housing, a filter member disposed in the filter housing, and a dust removing device disposed in the filter member for sweeping the filter member, to sweep of dirt from the filter member, and to allow the dirt to be removed from the filter member. The dust removing device includes one or more actuating members rotatably disposed in the filter member with such as a shaft for engaging with the filter member to sweep of dirt from the filter member when the actuating member is rotated relative to the filter member. A manually operating device is coupled to the shaft for rotating the shaft and the actuating member to sweep off the dust from the filter member.

### BACKGROUND OF THE INVENTION

1. Field of the Invention

The present invention relates to a vacuum collector or dust collector, and more particularly to a vacuum collector or dust collector having a stirring or sweeping or dust removing device disposed in a screen filter member, for sweeping and removing the dirt from the screen filter member and for allowing the dirt to be easily collected.

2. Description of the Prior Art

Typical vacuum or dust collectors comprise an array of drum filters and a frame disposed in a permanent operative position proximate the array, and a number of longitudinal members operatively disposed on the frame for receiving and filtering and collecting the dirt, and suction nozzles extended from tubes for drawing and collecting the dirt.

For example, U.S. Pat. No. 5,814,114 to Stueble discloses one of the typical vacuum collectors having a suction nozzle extended from each longitudinal member to operatively communicate with the drum filter for removing waste materials therefrom.

However, in the typical vacuum collectors, the suction nozzles are only extended toward the drum filter but may not be contacted or engaged with the drum filter such that the waste materials may not be effectively removed from the drum filter.

U.S. Pat. No. 7,186,281 to Cheng discloses another typical vacuum collector comprising a screen or ring having a number of brushing bristles provided on the outer circumferential edge portion of the ring, and two handles coupled to the brush base with pull ropes of a pull unit for allowing the dust to be removed or cleaned with the two pullable handles.

However, in the typical vacuum collectors, the pull ropes and the pull unit may be covered with the dusts or wastes and may not be effectively operated when the dust collecting tank is filled with the dirt or dust or waste materials.

The present invention has arisen to mitigate and/or obviate the afore-described disadvantages of the conventional vacuum or dust collectors.

### SUMMARY OF THE INVENTION

The primary objective of the present invention is to provide a vacuum or dust collector including a stirring or sweeping or dust removing device disposed in a screen filter member, for sweeping and removing the dirt from the screen filter member and for allowing the dirt to be easily collected.

The other objective of the present invention is to provide a vacuum or dust collector including a manually operated rotating or driving device for easily rotating or driving or operating the stirring or sweeping or dust removing device and arranged for allowing the manually operated rotating or driving device to be easily operated or actuated by the users.

In accordance with one aspect of the invention, there is provided a vacuum collector comprising a filter housing, a filter member disposed in the filter housing, a shaft rotatably disposed in a center portion of the filter housing, and including at least one actuating member extended from the shaft for engaging with the filter member and for sweeping off dirt from the filter member when the shaft and the actuating member is rotated relative to the filter member, and a spindle rotatably supported in the filter housing and coupled to the shaft for rotating the shaft to operate the actuating member to sweep off the dirt from the filter member.

The spindle includes a first engaging member attached thereto, and the shaft includes a second engaging member attached thereto and engaged with the first engaging member of the spindle for allowing the shaft to be rotated by the spindle. The engaging members may be selected from a bevel gear or the like.

The filter housing includes a bracket disposed therein for rotatably supporting the spindle. For example, the bracket includes two ears extended therefrom for rotatably supporting the spindle. A handle may further be provided and coupled to the spindle for actuating the spindle to rotate the shaft.

The filter housing includes an upper panel and a bottom bar, the shaft may be rotatably disposed between the upper panel and the bar of the filter housing. For example, the filter housing includes two seats attached to the upper panel and the bottom bar to rotatably support the shaft between the upper panel and the bar of the filter housing.

A duct may further be provided and supported on a supporting base, and the filter housing is disposed on the duct, and a vacuum pump is coupled to the duct for drawing the dirt into the filter housing via the duct. A dust bag may further be provided and attached to the duct and disposed below the filter housing for collecting the dirt.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a vacuum collector in accordance with the present invention;

FIG. 2 is a partial exploded view of a filter device for the vacuum collector;

FIG. 3 is another partial exploded view of the filter device for the vacuum collector;

FIG. 4 is a top plan schematic view of the filter device for the vacuum collector; and

FIG. 5 is a partial cross sectional view of the filter device taken along lines 5-5 of FIG. 4, illustrating the operation of the filter device of the vacuum collector.

### DETAILED DESCRIPTION OF THE PREFERRED EMBODIMENT

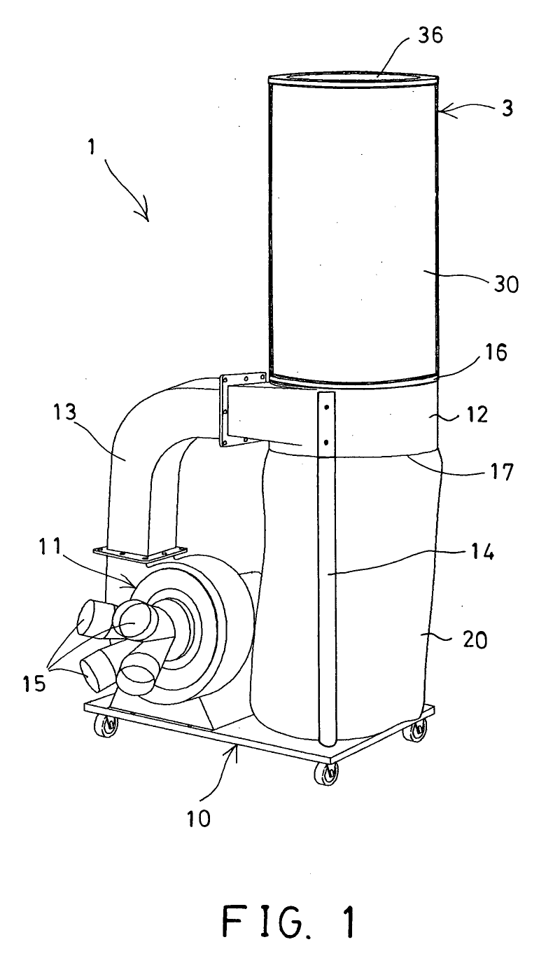

Referring to the drawings, and initially to FIG. 1, a vacuum collector 1 in accordance with the present invention comprises a base 10, an electric vacuum motor or pump 11 disposed on the base 10 for vacuuming purposes, one or more ducts 12 disposed on the base 10 and coupled to the vacuum pump 11 with manifolds 13 and/or one or more posts 14, and one or more, such as two filter devices 3 attached to the ducts 12 for filtering purposes. The vacuum pump 11 includes one or more ports 15 for coupling to trunks or duct arms or nozzles (not shown) or the like, and for directing toward the dust or dirt or fume to be collected, in order to vacuum or to drawn the dust or the dirt or the fume through the manifolds 13 and the ducts 12 and then into the filter devices 3 which may be provided for filtering and/or collecting the dust or the dirt.

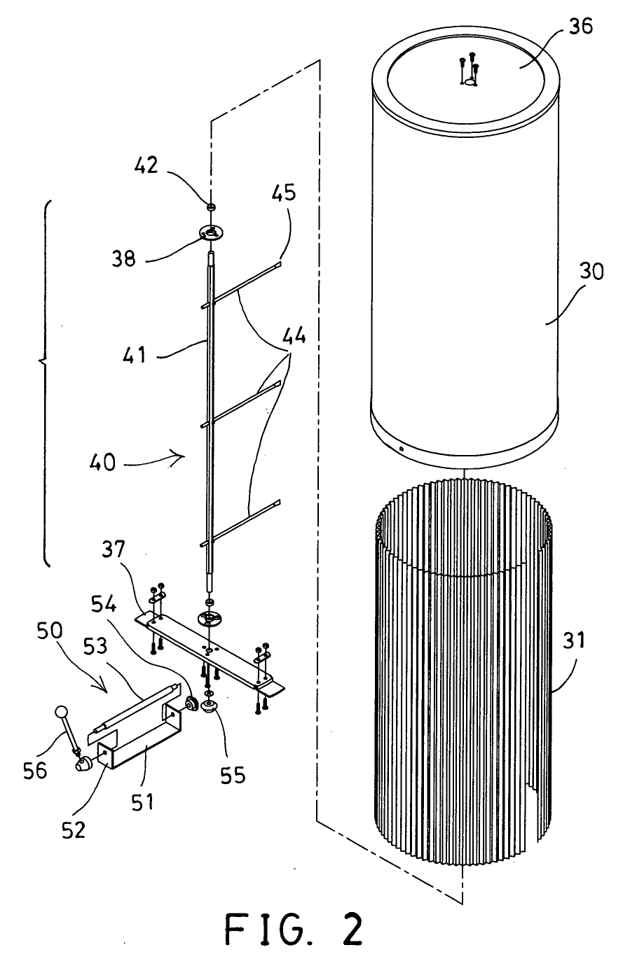

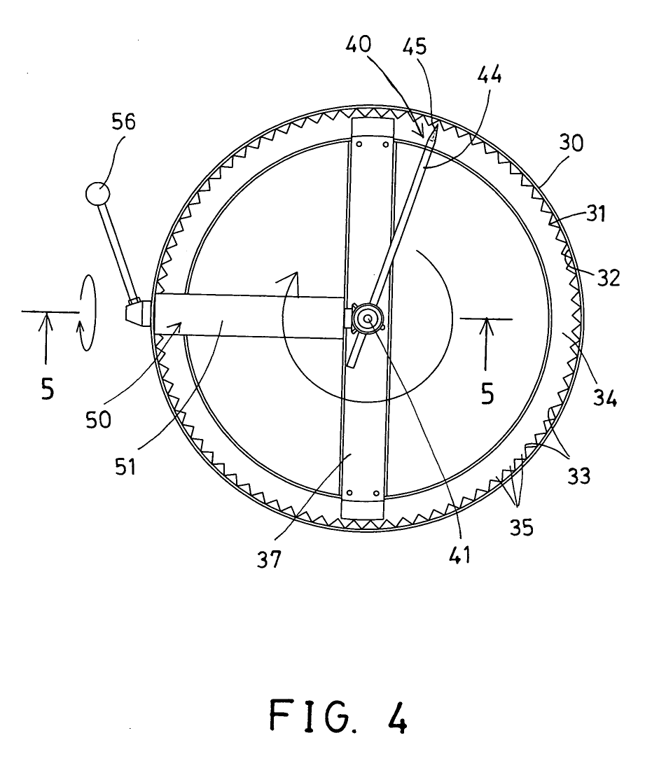

The filter devices 3 may be attached onto the ducts 12 with such as clamping or retaining rings 16, and preferably disposed above the ducts 12 respectively. One or more dust bags 20 may further be provided and attached onto the ducts 12 with such as clamping or retaining rings 17, and preferably disposed below the ducts 12 and the filter devices 3 respectively, for collecting the dust or the dirt filtered and/or collected by the filter devices 3. As shown in FIGS. 2 and 4, the filter device 3 includes a filter housing 30, and a filter member 31 disposed in the filter housing 30 and preferably snugly fitted within the filter housing 30, or contacted with an inner peripheral surface 32 of the filter housing 30, best shown in FIG. 4. It is preferable that the filter member 31 includes a serrated structure having a number of cusps 33 formed therein and extended inwardly into an inner chamber 34 of the filter member 31, and having a number of recesses 35 formed or defined between the cusps 33.

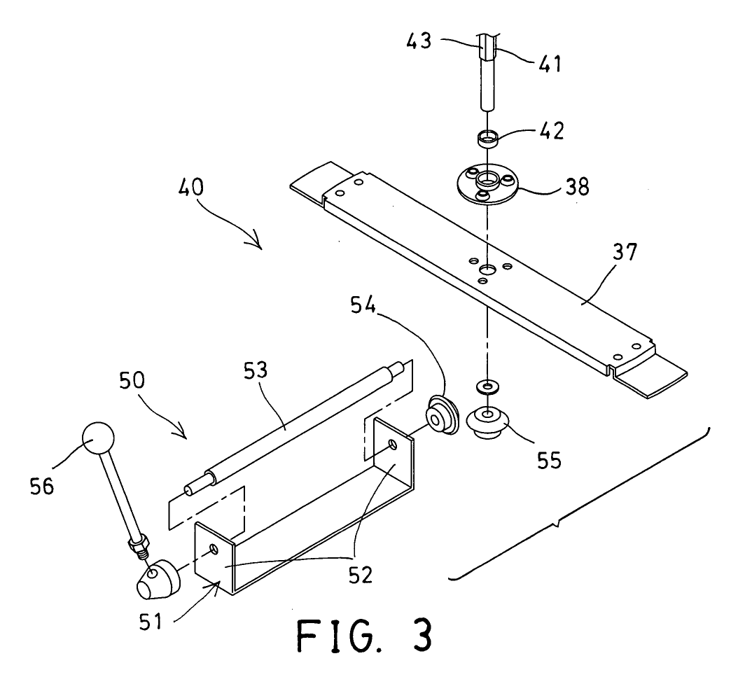

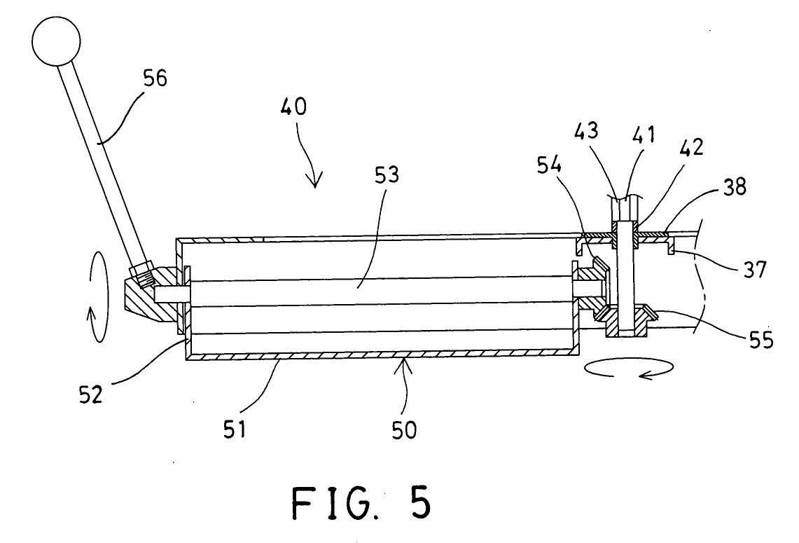

The filter housing 30 includes an upper panel 36, and includes a lower bar 37 attached to the bottom portion thereof, and includes two hubs or seats 38 attached to the upper panel 36 and the bar 37 respectively. As shown in FIGS. 2-5, a stirring or sweeping or dust removing device 40 is disposed in the filter housing 30 and the filter member 31, for sweeping the dust or the dirt from the filter member 31 and for allowing the dust or the dirt to be easily removed from the filter member 31 and/or to be easily collected within the dust bag 20. For example, the dust removing device 40 includes a shaft 41 rotatably disposed in the center portion of the filter member 31 and in the filter housing 30, and the shaft 41 includes two ends rotatably secured to the seats 38 with such as bearings 42 or the like. It is preferable that the shaft 41 includes a non-circular cross section, such as a triangular cross section, a square or rectangular cross section, a hexagonal cross section or the like, such that the shaft 41 may include two or more flat surfaces 43 formed thereon. The dust removing device 40 further includes one or more rods or flaps or sweeping or actuating members 44 secured onto the shaft 41, such as secured onto the flat surfaces 43 of the shaft 41. When the shaft 41 includes a triangular or a hexagonal cross section having three or six flat surfaces 43 formed thereon, it is preferable, but not necessarily that the actuating members 44 are secured onto the shaft 41 and arranged to have a 120° included angle formed therebetween or arranged toward different directions. The dust removing device 40 further includes one or more blades 45 of such as rubber or resilient materials secured to the free ends of the actuating members 44 for engaging with the filter member 31, such as for engaging with the cusps 33 of the filter member 31, in order to stir or to sweep off the dust or the dirt that may be attached onto the filter member 31, and thus for allowing the dust or the dirt to be collected within the dust bag 20.

As also shown in FIGS. 2-5, the dust removing device 40 further includes a manually operating means or device 50 coupled to the shaft 41 for rotating the shaft 41 and thus for actuating the actuating members 44 to engage with the filter member 31 in order to stir or to sweep off the dust or the dirt that may be attached onto the filter member 31. For example, the operating means or device 50 includes a U-shaped bracket 51 attached to or disposed in the filter housing 30 and having two ears 52 extended upwardly therefrom for rotatably supporting a spindle 53 on the ears 52 and/or in the filter housing 30, an engaging member 54, such as a bevel gear 54 is secured to the spindle 53 and rotated in concert with the spindle 53, and another engaging member 55, such as a bevel gear 55 is secured to the shaft 41 and rotated in concert with the shaft 41 and engaged with the engaging member 54 of the spindle 53, for allowing the shaft 41 to be rotated by the spindle 53, and a handle 56 is attached or coupled to the spindle 53 for actuating the spindle 53 to rotate the shaft 41 and thus to operate the actuating members 44 to sweep off the dust or the dirt from the filter member 31.

Accordingly, the vacuum collector in accordance with the present invention includes a stirring or sweeping or dust removing device disposed in a screen filter member, for sweeping and removing the dirt from the screen filter member and for allowing the dirt to be easily collected.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A dust collector comprising:
a filter housing,
a filter member disposed in said filter housing,
a shaft rotatably disposed in a center portion of said filter housing, and including at least one actuating member extended from said shaft for engaging with said filter member and for sweeping off dirt from said filter member when said shaft and said at least one actuating member is rotated relative to said filter member, and
a spindle rotatably supported in said filter housing and coupled to said shaft for rotating said shaft to operate said at least one actuating member to sweep off the dirt from said filter member.

2. The dust collector as claimed in claim 1, wherein said spindle includes a first engaging member attached thereto, and said shaft includes a second engaging member attached thereto and engaged with said first engaging member of said spindle for allowing said shaft to be rotated by said spindle.

3. The dust collector as claimed in claim 2, wherein said first engaging member is a bevel gear.

4. The dust collector as claimed in claim 2, wherein said second engaging member is a bevel gear.

5. The dust collector as claimed in claim 1, wherein said filter housing includes a bracket disposed therein for rotatably supporting said spindle.

6. The dust collector as claimed in claim 5, wherein said bracket includes two ears extended therefrom for rotatably supporting said spindle.

7. The dust collector as claimed in claim 1, wherein a handle is coupled to said spindle for actuating said spindle to rotate said shaft.

8. The dust collector as claimed in claim 1, wherein said filter housing includes an upper panel and a bottom bar, said shaft is rotatably disposed between said upper panel and said bar of said filter housing.

9. The dust collector as claimed in claim 8, wherein said filter housing includes two seats attached to said upper panel and said bottom bar to rotatably support said shaft between said upper panel and said bar of said filter housing.

10. The dust collector as claimed in claim 1 further comprising a duct, said filter housing being disposed on said duct, and a vacuum pump coupled to said duct for drawing the dirt into said filter housing via said duct.

11. The dust collector as claimed in claim 10 further comprising a dust bag attached to said duct and disposed below said filter housing for collecting the dirt.
